(19) United States
(12) Patent Application Publication
(10) Pub. No.: US 2025/0150423 A1
(43) Pub. Date: May 8, 2025

(54) ADAPTABLE NOTIFICATIONS FOR INCOMING MESSAGES

(71) Applicant: MICROSOFT TECHNOLOGY LICENSING, LLC, Redmond, WA (US)

(72) Inventor: Michael J. BURFORD, Seattle, WA (US)

(21) Appl. No.: 18/504,819

(22) Filed: Nov. 8, 2023

(51) Int. Cl. H04L 51/224; H04L 51/04; H04L 51/216

(52) U.S. Cl. CPC H04L 51/224; H04L 51/04; H04L 51/216

(57) ABSTRACT

The techniques disclosed herein provide adaptable notifications for incoming messages. A system uses AI to recognize one or more categories for individual messages of a thread. The system can then generate a summary of specific categories of messages to provide contextually relevant notifications that summarize a specific set of interactions for a message thread. This approach is more efficient than systems that provide individual notifications for each message, as the disclosed techniques enable a system to generate a controlled number of notifications and/or more contextually accurate notifications for specific users. The disclosed techniques also improve the security of a system by generating notifications that can summarize the content of received messages and/or summarize specific interactions within a particular message thread.

### BACKGROUND

There are a number of systems that allow users to communicate. For example, some systems allow people to collaborate by sharing content using video streams, shared files, chat messages, etc. Some systems allow people to share messages on threads that are part of an on-line meeting, a group conversation within a document or spreadsheet, or a social media application operating on a mobile device. Such systems generate notifications when messages are received. A notification can be generated when a device is locked or when the device is displaying another application other than the communication application displaying the received messages.

Although existing systems provide features that allow people to share content within a message thread, some of these systems still have a number of drawbacks. For example, some existing systems do not have effective features when it comes to providing notifications. In most systems, a notification is generated each time that user receives a message. These notifications can appear when a device is in a lock screen mode or notifications can appear when a person is working within another application. Such delivery techniques can lead to a number of inefficiencies with respect to computing resources. When participants engage in an on-line chat session, a user can be inundated with notifications, which can lead to a scenario where notifications are ignored. This often leads to a situation where users turn off their notifications, or it may lead to a situation where networking resources, processing resources, and screen space are unnecessarily utilized to display notifications and content that are ignored or turn out to be unimportant to a user. These issues are exacerbated by the fact that some meetings can include hundreds of participants that may contribute large volumes of messages to one thread.

Traditional notification delivery techniques also make it difficult for a user to follow a conversation as they have to monitor notifications in real time to understand the context of a conversation. If the user does not track notifications closely, messages may be misinterpreted, which can lead to unnecessary reactions. When a notification is received, a user may have to review the details of a thread to determine if a message actually pertains to them. This leads to a situation where users may have to check a thread more often than needed. This leads to unnecessary use of computing resources and less than optimal user experiences when it comes to interactions with a device. Security issues may also be a concern when a device utilizes simplified notification features. Sensitive data may also be displayed if a device indiscriminately displays content of a message in a notification. At the same time, if a system indiscriminately screens all types of data, a notification may not provide enough information to help the user understand the interactions of a thread.

### SUMMARY

The techniques disclosed herein provide adaptable notifications for incoming messages. In some embodiments, a system uses artificial intelligence (AI) to recognize one or more categories for individual messages of a thread. The system can then generate a summary of specific categories of messages to provide contextually relevant notifications that summarize a specific set of interactions for a message thread. This approach is more efficient than systems that provide individual notifications for each message, as the techniques disclosed herein allows a system to generate a controlled number of notifications and/or more contextually accurate notifications for specific users. In addition, the disclosed techniques improve the security of a system by generating notifications that can summarize the content of received messages or summarize specific interactions within a particular message thread.

In one illustrative example, a system can determine a category for each incoming message. For example, a system can categorize a first message as a question, and categorize subsequent messages as answers pertaining to the question of the first message. The system can then generate a summary of that specific set of interactions. For example, a first notification can be generated in response to a first message containing a question can include a summary of the question, and also provide a graphical element indicating that a question has been presented to a specific thread. The graphical element can be in the form of a reaction emoji, an icon, etc. Then later, a second notification can be generated in response to one or more messages containing answers to the question. The second notification can include a summary of the question, a graphical element indicating that the question has been answered, and a summary of a number of messages that included answers. The summaries can be generated by the use of one or more AI models, including the use of a large language model.

The system can also associate a specific group of messages relating to an event and generate or suppress a notification that summarizes or represents the specific group of messages pertaining that event. The system can also suppress messages based on the time of the message and the time of the event. This allows the system to suppress notifications for messages that are received after the event or if the event is cancelled. Such features help mitigate the receipt of volumes of unnecessary notifications. The system can also update or modify notifications based on new messages pertaining to the event. The system can also be configured to filter the display of messages, e.g., messages that are not related to the event or messages that are received after the event do not cause updates to the notification.

In some configurations, the system can also generate customized notifications that can convey specific types of activity pertaining to a chat thread. In some configurations, the specific types of activity can be represented by the use of emojis or a summary without the display of any shared content. For example, consider a scenario where there is a chat thread with a dozen users and two of those users are exclusively engaged in a conversation. The system can detect this exclusive activity for a subset of participants of a thread, and in response, the system can generate a customized notification to other users showing that the subset of participants are engaged with one another. This customized notification can include the names of the subset of participants along with a number of messages that are exchanged between the subset of participants. In addition, the customized notification can include graphical indicators showing who is sending and receiving the messages. For example, the system may display arrows between usernames to show who sent and who received the last message. The customized notifications that are sent to the other users may not include summaries of the messages unless the other users become active in the conversation with the subset of participants. While the customized notifications are generated for the other users other than the subset of users, the system can generate other types of notifications for the subset of participants, and those notifications can include content of the shared messages. These notifications can include summaries or redacted versions of the shared content.

The disclosed techniques address the technical problems of inefficient device interaction by providing a technical solution of controlling the display of notifications by suppressing the display of new notifications and or modifying existing notifications for incoming messages. This can improve human interaction based on a reduced number of notifications that are displayed. The disclosed techniques can improve human interaction by condensing a number of notifications to more understandable and usable formats. Some existing systems that generate notifications for each message require users to closely monitor their notifications to understand a conversation. This is cumbersome and may be misleading for users if they are not able to see all of the displayed notifications.

The disclosed techniques address the technical problems of inefficient use of computing resources by providing technical solutions that reduce, suppress, combine, and/or modify notifications by the use of AI models that interpret and categorize specific groups of incoming messages. A system that generates notifications for each message takes a considerable amount of network resources and processing resources, along with unnecessarily using screen space, particularly when a thread has hundreds or thousands of messages. By controlling a number of notifications that are generated and displayed, a system can improve the efficiency of that device while also improving a person's interaction with the device. In addition, the disclosed techniques provide a number of security features by reducing, suppressing and summarizing content of messages for notifications. The use of AI can cause a system to remove sensitive content by sending a specific prompt to a language model with any given message, causing the language model to generate a redacted summary of the message or a summary of the activity of a thread, e.g., a number of reactions, a number of messages between specific users, etc.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A illustrates a first user interface arrangement that is generated by a first device in a first operating mode where an application for displaying messages of a thread is executing, and a second user interface arrangement that is generated by a second device that is in a second operating mode that is in lock screen or operating an application that does not display the messages of the thread.

FIG. 1B illustrates the first user interface arrangement showing a first message of a first topic that is generated by a first device in a first operating mode where an application for displaying messages of a thread is executing, and a second user interface arrangement showing a first notification for the first message, where the first notification is generated by a second device that is in a second operating mode that is in lock screen or operating an application that does not display the messages of the thread.

FIG. 1C illustrates the first user interface arrangement showing a second message of a second topic that is generated by a first device in a first operating mode where an application for displaying messages is executing, and a second user interface arrangement showing a second notification for the second message, where the second notification is generated by a second device that is in a second operating mode that is in lock screen or operating an application that does not display the messages of the thread.

FIG. 1D illustrates the first user interface arrangement showing a third message of the first topic that is generated by a first device in a first operating mode where an application for displaying messages of a thread is executing, and a second user interface arrangement showing a modified version of the first notification for the third message, where the modified version of the first notification is generated by the second device is in the second operating mode that is in lock screen or operating an application that does not display the messages of the thread.

FIG. 2 shows a series of messages of a thread and notifications that are generated in response to each message.

FIG. 3 shows a series of messages of a thread pertaining to multiple topics and notifications that are generated in response to each message.

FIG. 4A illustrates the first user interface arrangement showing a first message that is generated by a first device in a first operating mode where an application for displaying messages of a thread is executing and displayed as a primary application, and a second user interface arrangement showing a first notification for the first message, where the first notification is generated by a second device that is in a second operating mode that is in lock screen or operating an application that does not display the messages of the thread.

FIG. 4B illustrates the first user interface arrangement showing a second message that is generated by a first device in a first operating mode where an application for displaying messages is executing, and a second user interface arrangement showing a second notification for the second message, where the second notification is generated by a second device that is in a second operating mode that is in lock screen or operating an application that does not display the messages of the thread.

FIG. 4C illustrates a first update to a notification on a second device in response to a reaction in a private conversation with a subset of users of other devices.

FIG. 4D illustrates a second update to a notification on a second device in response to a reaction in a private conversation with a subset of users of other devices.

FIG. 4E illustrates a third update to a notification on a second device in response to a reaction in a private conversation with a subset of users of other devices.

FIG. 5A illustrates the first user interface arrangement showing a first message sent by a first device operating in a first mode.

FIG. 5B illustrates the second user interface arrangement showing a notification of a first device operating a second mode, where the notification shows a number of reactions for a message sent by the first device.

FIG. 5C illustrates the second user interface arrangement showing an updated notification of a first device operating a second mode, where the updated notification shows an updated number of reactions for a message sent by the first device.

FIG. 5D illustrates the second user interface arrangement showing another updated notification of a first device operating a second mode, where the other updated notification shows an updated number of reactions for a message sent by the first device.

FIG. 6A illustrates a first phase of a process where a computer displays a first user interface arrangement having an expandable notification that is displayed in a lock screen mode.

FIG. 6B illustrates a second phase of a process where a computer displays a first user interface arrangement having an expandable notification that is displayed in a lock screen mode, where a user input causes the expandable notification to increase in size and show additional content of received messages.

FIG. 6C illustrates a third phase of a process where a computer displays a first user interface arrangement having an expandable notification that is displayed in a lock screen mode, where a user input of one topic of multiple topics has caused the expandable notification to increase in size and show additional content of received messages for the one topic.

FIG. 6D illustrates a fourth phase of a process where a computer displays a first user interface arrangement having an expanded notification receives a user input and causes a transition to a second user interface showing messages related to a selected topic.

FIG. 6E illustrates a fifth phase of a process where a computer displays a second user interface arrangement shown after an operating mode transition, where messages of a selected topic are displayed in response to a user input of an expanded notification.

FIG. 7 is a flow diagram showing aspects of a routine capable of implementing aspects of the techniques and technologies presented herein.

FIG. 8 is a diagram illustrating a distributed computing environment capable of implementing aspects of the techniques and technologies presented herein.

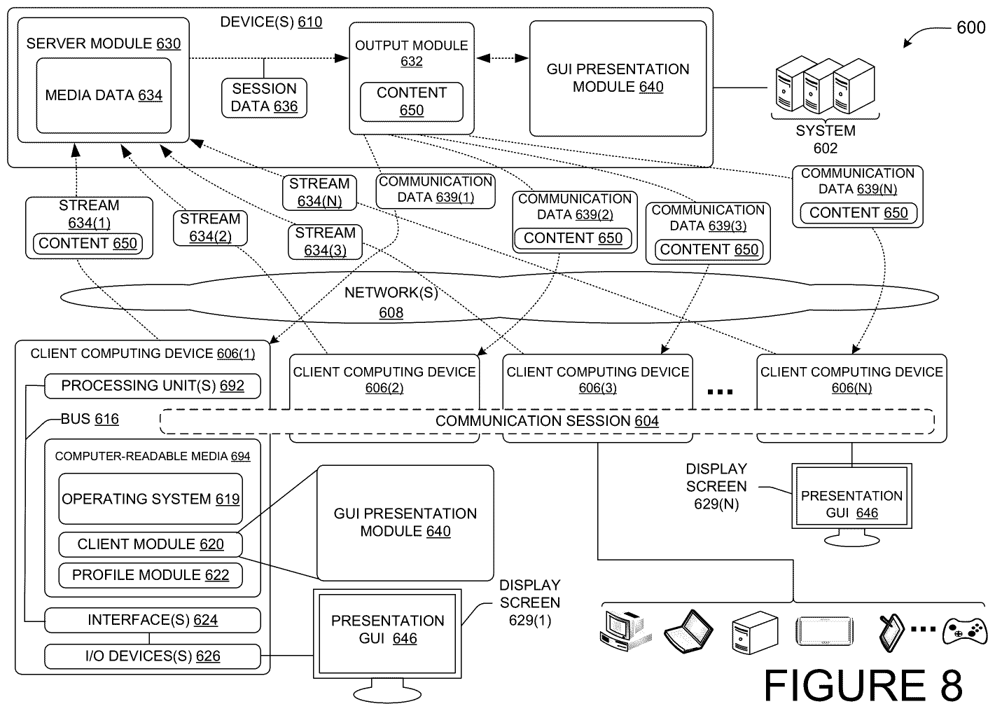

FIG. 9 is a computer architecture diagram illustrating a computing device architecture for a computing device capable of implementing aspects of the techniques and technologies presented herein.

### DETAILED DESCRIPTION

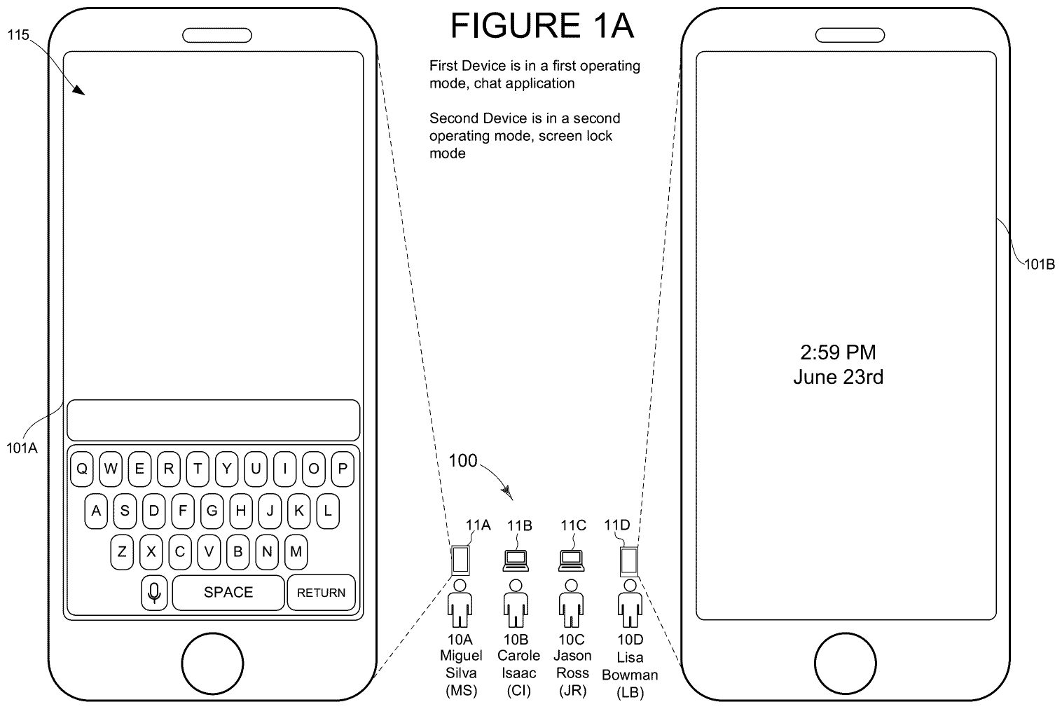

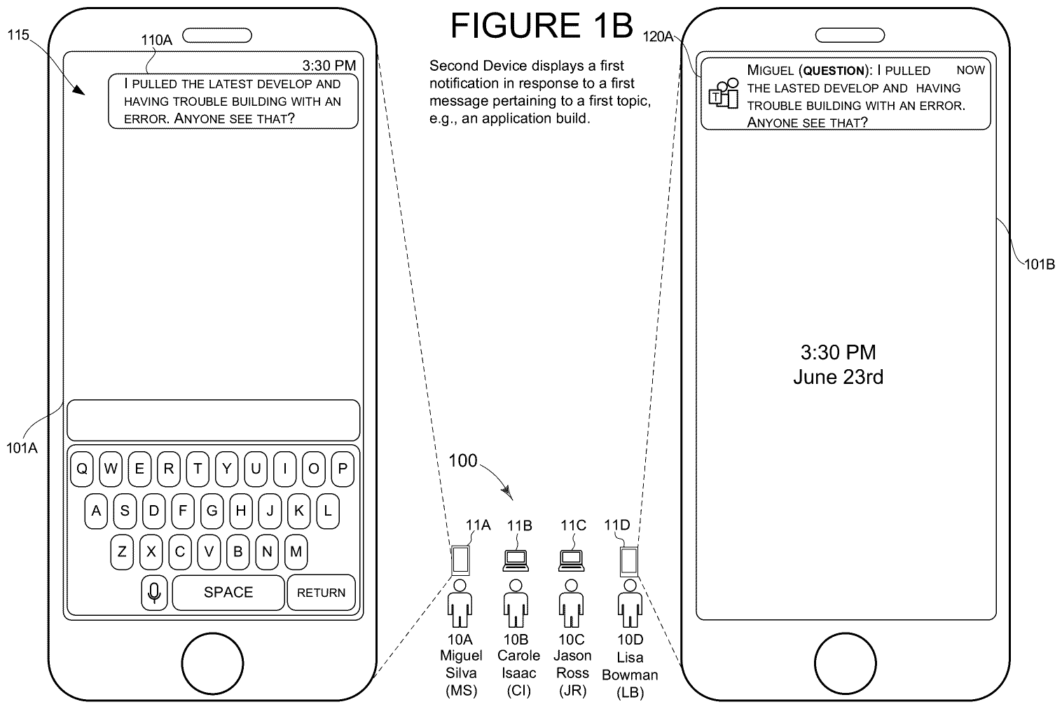

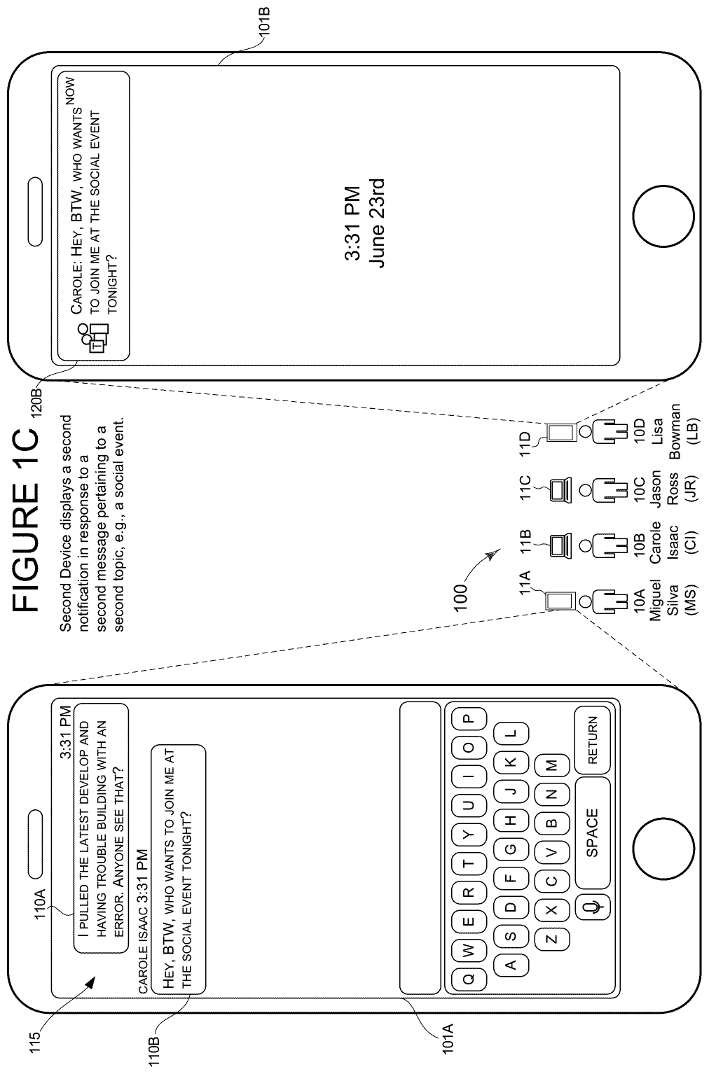

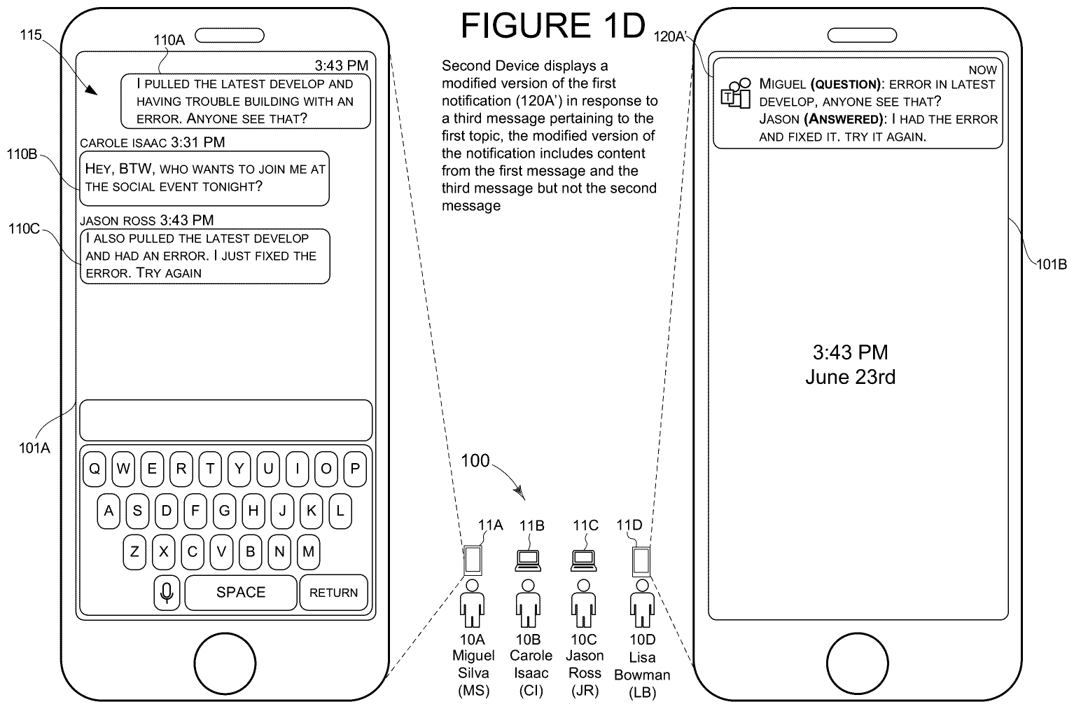

FIGS. 1A through 1D show an example of how a system having two devices running in two different operating modes can provide adaptable notifications for incoming messages. As shown in FIG. 1A, a system 100 can include a number of computers 11 each corresponding to individual users 10. For illustrative purposes, a first user 10A, Miguel Silva, is associated with a first computer 11A, a second user 10B, Carole Isaac, is associated with a second computer 11B, a third user 10C, Jason Ross, is associated with a third computer 11C, and a fourth user 10D, Lisa Bowman, is associated with a fourth computer 11D. The devices and users can also be respectively referred to as “Device A,” Device B,” . . . “User A,” User B,” etc. Although this system shows only four devices and four users, it can be appreciated that the disclosed techniques can be used on any number of devices for any number of users. In addition, other types of devices can be used, including desktop computers, tablets, head-mounted display devices, etc.

FIG. 1A illustrates a first user interface arrangement that is generated by a first device 11A in a first operating mode. The first operating mode includes execution of a messaging application that is configured to display a thread 115 of messages in a first user interface arrangement 101A. In the first operating mode, a device screen is not locked and input devices such as the touch screen or a keyboard allow text entry to the messaging application. FIG. 1A also illustrates a second user interface arrangement 101B that is generated by another device 11D in a second operating mode. The second operating mode includes features that lock the screen of the device. Alternatively, the second operating mode includes execution of an application that does not display the thread 115 of messages and/or a messaging application that displays messages is running the background. For instance, the other device 11D can be in the second operating mode while executing a spreadsheet application in the foreground while the message application is operating in the background, e.g., the message application is not currently displayed on the screen. When in the second operating mode, the device may restrict an input at an input device from text entry to the messaging application.

Turning now to FIG. 1B, while in their respective operating modes, the system receives a first message 110A pertaining to a first topic. This can be displayed on a screen of any one of the devices, such as the first device 11A. In response to receiving the first message 110A, the system causes a display of a first notification 120A comprising at least a portion of the first message 110A. As shown in FIG. 1C, while in their respective operating modes, the system receives a second message 110B pertaining to a second topic. In response to receiving the second message 110B, the system causes a display of a second notification 120B comprising at least a portion of the second message 110B.

As shown in FIG. 1D, the system receives a third message 110C. In response to the third message, the system analyzes the third message 110C to determine that a topic of the third message 110C has a threshold level of relevancy to the first topic of the first message 110A. In addition, the system can analyze the third message 110C to determine that the topic of the third message 110C has a threshold level of relevancy to the second topic of the second message 110B.

The system can achieve this analysis by the use of a number of different techniques. In one illustrative example, the system can send the received messages to a Natural Language Processing (NLP) module, which may include the use of generative AI technologies, and more specifically in one example, a large language model (LLM). Although the examples disclosed herein refer to the use of an LLM, the techniques disclosed herein can utilize any combination of suitable NLP algorithms that analyze and model interactions between devices and human language. This can include, but is not limited to, any suitable combination of algorithms such as Tokenization algorithms that divide a text into individual words or tokens; Part-of-Speech (POS) Tagging algorithms that assign grammatical labels (e.g., noun, verb, adjective) to each word in a sentence, helping to analyze sentence structure; Named Entity Recognition (NER) algorithms that identify and classify named entities, such as names of people, places, organizations, and more within a text; Sentiment Analysis algorithms that determine the sentiment or emotional tone of a piece of text, and classifying it as positive, negative, or neutral; Text Classification algorithms that categorize text documents into predefined classes or categories, such as topic classification and sentiment analysis; Machine Translation algorithms, like neural machine translation (NMT), automatically translate text from one language to another; Language Modeling algorithms, including n-grams and neural language models, an also to referred to herein as a large language model (LLM) or a “language model,” are used to predict the probability of a word or sequence of words given the context of the preceding words; Named Entity Disambiguation algorithms which help disambiguate the meaning of named entities by linking them to specific entities in a knowledge base or resolving them to their appropriate entities; Text Summarization algorithms that generate concise summaries of longer texts, which can be extractive (selecting and combining sentences) or abstractive (generating new sentences); Speech Recognition algorithms, since the system may process speech messages and not just text messages; Information Extraction algorithms that identify structured information from unstructured text, for extracting events or facts from articles or message attachments; Coreference Resolution algorithms that determine which words or phrases in a text refer to the same entity, e.g., identifying that “he” and “John” refer to the same person in a sentence; Question Answering algorithms that answer questions posed in natural language by extracting relevant information from text corpora or knowledge bases; Word Embeddings algorithms that represent words as dense, continuous-valued vectors, which capture semantic relationships between words; Text Generation algorithms that use Recurrent Neural Networks (RNNs) and Transformers to create human-like text, including chatbots, content generation, and creative writing, Dependency Parsing algorithms that analyze the grammatical structure of sentences by identifying the relationships between words, including subjects, objects, and modifiers; Topic Modeling algorithms, such as Latent Dirichlet Allocation (LDA), to uncover the underlying topics in a collection of documents; and Language Generation algorithms that create coherent and contextually relevant language, such as generating human-like responses in a conversational AI system.

The received messages can also be sent to the LLM in conjunction with a prompt that can cause the language model to determine a relevancy level between any combination of messages. For example, this system can generate a prompt requesting a level relevancy level between the third message and the first message. The prompt can also include a request for a confidence level with respect to the relevancy level. This can cause the language model to return a value indicating irrelevancy level between each combination of messages and another value indicating a confidence level. If the relevancy level or a combination of the relevancy level and the confidence level, exceed one or more thresholds, the system can determine that the topic of the third message and the topic of the first message have a threshold level of relevancy.

These determined values using the language model allow the system to determine that a notification for the first message belonging to the same topic was already delivered and, rather than delivering another notification, the system can either suppress a notification for the third message or cause a change to the first notification to reflect the new message, e.g., the third message. For illustrative purposes, in this example, the topic of the third message is determined to have a threshold level of relevancy with the topic of the first message. Also, in this example, the topic of the second message is determined to not have a threshold level of relevancy with the third message, and the determined relevancy level between the second message and the third message has a threshold confidence level. In addition, the topic of the second message is determined to not have a threshold level of relevancy with the first message, and the determined relevancy level between the second message and the first message has a threshold confidence level. In some embodiments, the system can accept and utilize the relevancy level values only if a confidence score for each determined relevancy level is above a confidence threshold. If the confidence scores are above a confidence threshold, the system may generate a modified version of the notification. However, if the confidence scores are not above a confidence threshold, the system may treat a corresponding message as a new message and generate a standalone notification.

Also shown in FIG. 1D, in response to determining that the topic of the third message 110C has a threshold level of relevancy to the first topic of the first message 110A, the topic of the third message 110C does not have a threshold level of relevancy to the topic of the second message, and determining that the first notification 120A for the first message 110A has been displayed, the system can cause a display of a modified version of the notification 120A′ for the first message 110A. In some embodiments, the system can cause the display of the modified version of the notification 120A′ in response to determining that a relevancy level between the topic of the third message 110C and the topic of the first message 110A meets a relevancy threshold, determining that a confidence level for the relevancy level meets a confidence threshold, and/or determining that the first notification 120A for the first message 110A has been displayed. In such embodiments, the display of the modified version of the notification 120A′ may be restricted if the confidence level for the relevancy does not meet the confidence threshold, which in this case, a new notification for the third message would be generated.

In some embodiments, the modified version of the notification 120A′ includes at least a portion of the third message 110C and content from the first message 110A. A process of modifying a notification can include the display of the first notification 120A, as shown in FIG. 1B. Where the first notification 120A contains content from the first message and/or a determined category of the first message. The first notification 120A of FIG. 1B can then transition to the modified version of the notification 120A′, as shown in FIG. 1D. This transition can include the addition of content from the third message and/or a determined category for the third message. In this example, the system adds an excerpt from the third message and a determined category of the third message to the modified version of the notification 120A′The modified version of the notification 120A′ can also exclude content from the second message 110B since it is not relevant to the third message. The content of the first message and the third message may include an excerpt from the messages or a summary of the messages. The determined categories can include a topic of each message. For example, the display of the determined category can be text or an image indicating that the first message is a question and text or an image indicating that the third message is an answer to the question.

As described in more detail below, a summary of a message can be generated by the use of one or more NLP algorithms. For example, each embodiment disclosed herein, one or more messages can be sent to an LLM with a prompt causing the LLM to summarize each message using one or more parameters. The parameters can define a maximum length of a summary, directives to include names of participants in a summary, etc. The prompt for causing the generation of a summary of a message can also be sent with a history of messages along with the most recent message. A prompt referring to the message history enables the system to generate a summary of the most recent message using the context of all previously received message.

As also described in more detail below, the modified version of the notification 120A′ can also include determined categories for the first message and the third message. This may be in conjunction with the display of the content of the messages, or the original notification 120A and the modified notification 120A′ can only include the determined categories. For example, if the first message is determined to be a question, the original notification 120A may include text or a graphic indicating a question is received. If the third message is determined to be an answer to the question, the modified version of the notification 120A′ may indicate the first determined category, e.g., a question was received, and indicate the other determined category for the third message, e.g., that the question was answered. The examples provided below show how the system uses an LLM to generate the determined categories.

In some embodiments, instead of displaying the modified version of the notification 120A′ for the first message, the system can suppress the display of a new notification for the third message 110C. The suppression of the notification for the third message can be in response to determining that the topic of the third message 110C has a threshold level of relevancy to the first topic of the first message 110A and determining that the first notification 120A for the first message 110A has been displayed. Thus, in FIG. 1D, on the fourth device 11D, the screen may not display a notification based on the third message 110C.

In some embodiments, the system can also determine a category for each incoming message. For example, a system can categorize the first message as a question and categorize other messages as answers pertaining to the question of the first message. The system can then generate a summary of that specific set of interactions, e.g., the messages, using labels within each message to identify the categories. For example, as shown in FIG. 1B, the first notification 120A can be generated in response to determining that the first message contains a question. The first notification 120A can include a summary of the question, and also provide a graphical element indicating that a question has been presented in a message of a specific thread. The graphical element can be in the form of a text label stating the message is a question, an emoji, an icon, etc. Then later, as shown in FIG. 1D, a second notification, or a modified version of the first notification, can be generated in response to the third message containing an answer to the question. The second notification can include a summary of the question, a graphical element indicating that the question has been answered, and a summary of message that included an answer.

The categories for each message can be determined using any suitable combination of natural language processing (NLP) algorithms. For example, the system may generate a query that causes a LLM to determine a category for a message. For illustrative purposes, a determined category can also be referred to herein as a topic. The query can include text such as, “is the last message a question or an answer to a question of a previous message.” The query can be sent to an LLM with a collection of the messages with timestamps of each message. Then, the system can send a similar query for each subsequent message. The queries can include instructions to cause the LLM to determine categories for each message, a relationship between each message, a summary of each message, and a confidence level for each determination. In response to receiving a collection of the messages shown in FIG. 1D and the above-described query, the LLM may generate data indicating a relationship between each message. This may be in the form of a map representing associations between messages that are questions and messages that are answers to the question. The model may generate data that labels each message as a question or answer. The labels may be generic, such as a “question” or an “answer” or the labels may be more specific, e.g., “question regarding a build.” In addition, the model may generate data that summarizes each message.

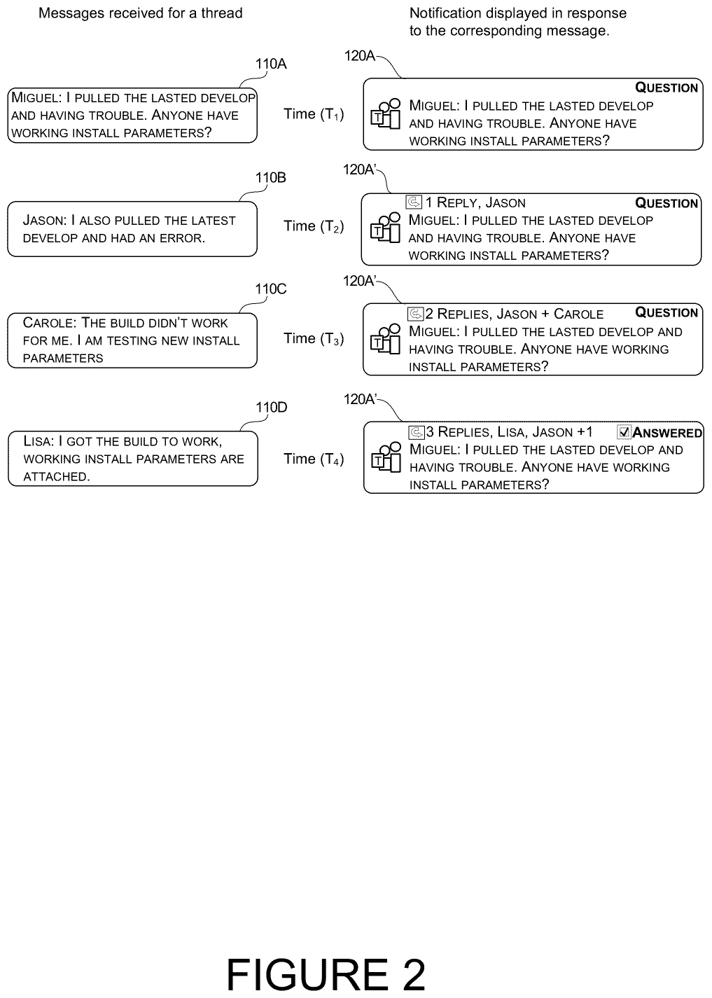

FIG. 2 shows another example of notifications having message labels pertaining to a detected category. The messages in this example show a set of interactions that cause the system to generate customized notifications based on the detection of messages that are associated with one another. The messages are received in a sequence within a timeline, with each message received at T₁, T₂, T₃, and T₄. The system generates individual notifications 120 in response to each message at T₁, T₂, T₃, and T₄.

To generate each notification, the system generates individual queries for each received message, and each query can be configured to cause an LLM to determine a relationship between the received message and any previously received messages. In addition, the system generates queries that cause the LLM to determine a category for each message. The query can also suggest a set of categories, such as a question or answer to guide the LLM response. The query can also cause the LLM to analyze each message and determine specific topics, such as a school subject or project at the office. In response to the queries, the LLM can return data indicating categories for each message and generate a notification using those labels and a summary of each corresponding message. For example, the first notification 120A is generated in response to the first message 110A, where the system determines the first message is a question and the notification has a corresponding label indicating that identified category. In this example, the second message 110B and the third message 110C cause the LLM to generate data indicating that messages are not answers to the question, and thus the corresponding notifications are just modifications to the first notification, and each modification just indicates a number of replies with identities of users who provided the replies. In this example, the fourth message 110D causes the LLM to generate data indicating that the message 110D is an answer to the question, and thus the corresponding notification 120A′ at T₄ is labeled as an answer to the question.

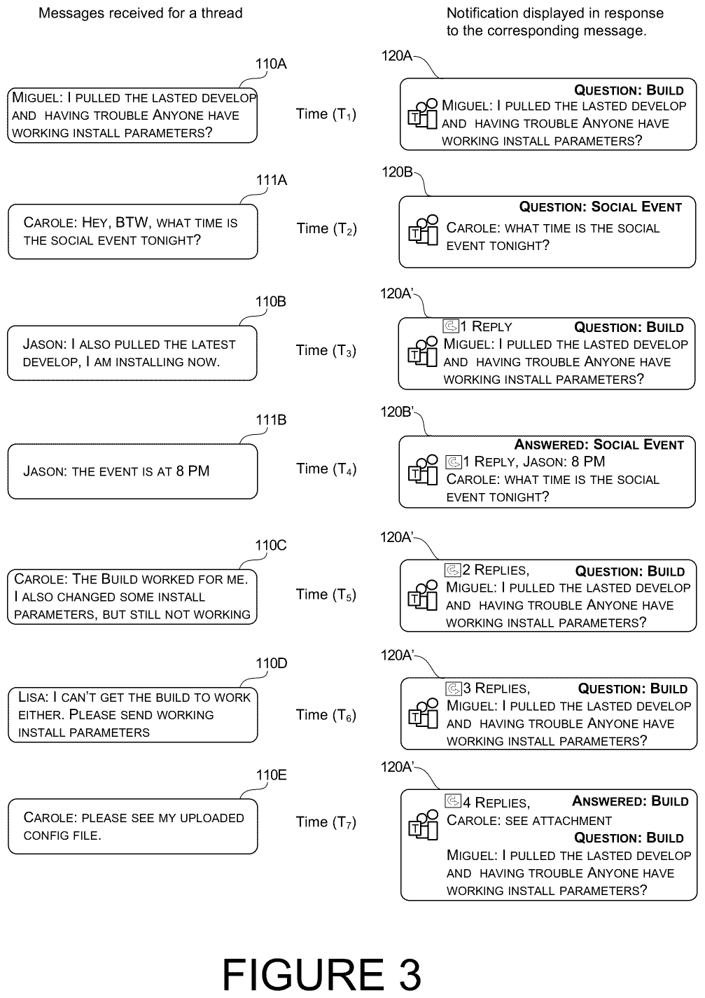

FIG. 3 shows another example of notifications having message labels pertaining to detected categories that involve topics, events, and times of the events. The messages in this example show a set of interactions that cause the system to generate customized notifications based on the detection of messages that are associated with a question, and a detection of messages related to an event. In this example, each detected category of messages causes the generation of individual sets of notifications. For example, the first set of messages 110 are related to a software build, and those messages 110 cause a generation of a first set of notifications 120A that are contextually related to the build. The second set of messages 111 are related to an event, and those messages 111 cause a generation of a second set of notifications 120B that are contextually related to the event. As shown, the determined labels can be included in each notification, e.g., each notification is marked as related to the build question or the social event. The notifications can also include counters showing how many times a message was received with respect to a particular message category, and the status of each category. The notification can indicate if a particular question was answered or if the question is still unanswered. In some cases, such as the modified notification at Time T₇, the notification can include questions and answers for multiple categories.

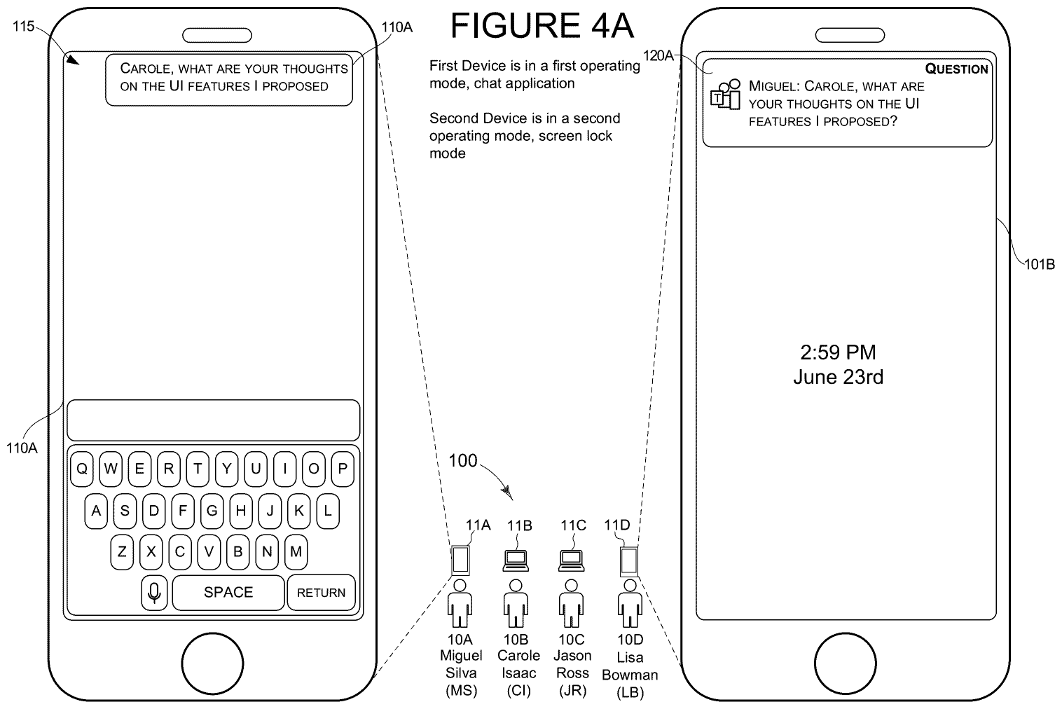

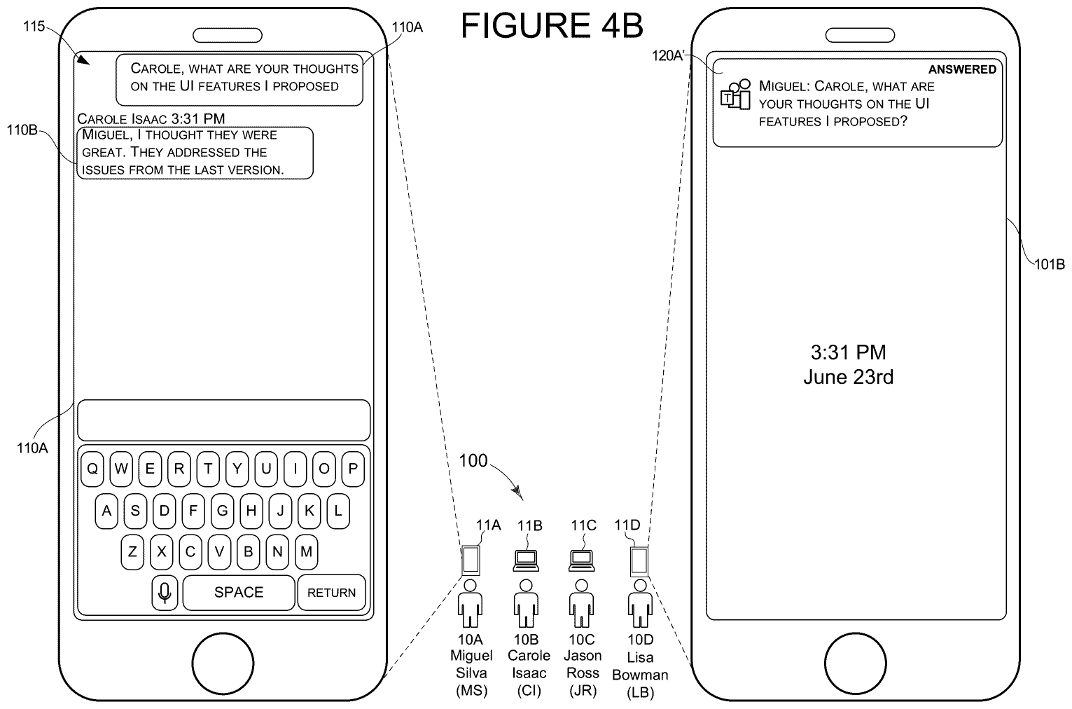

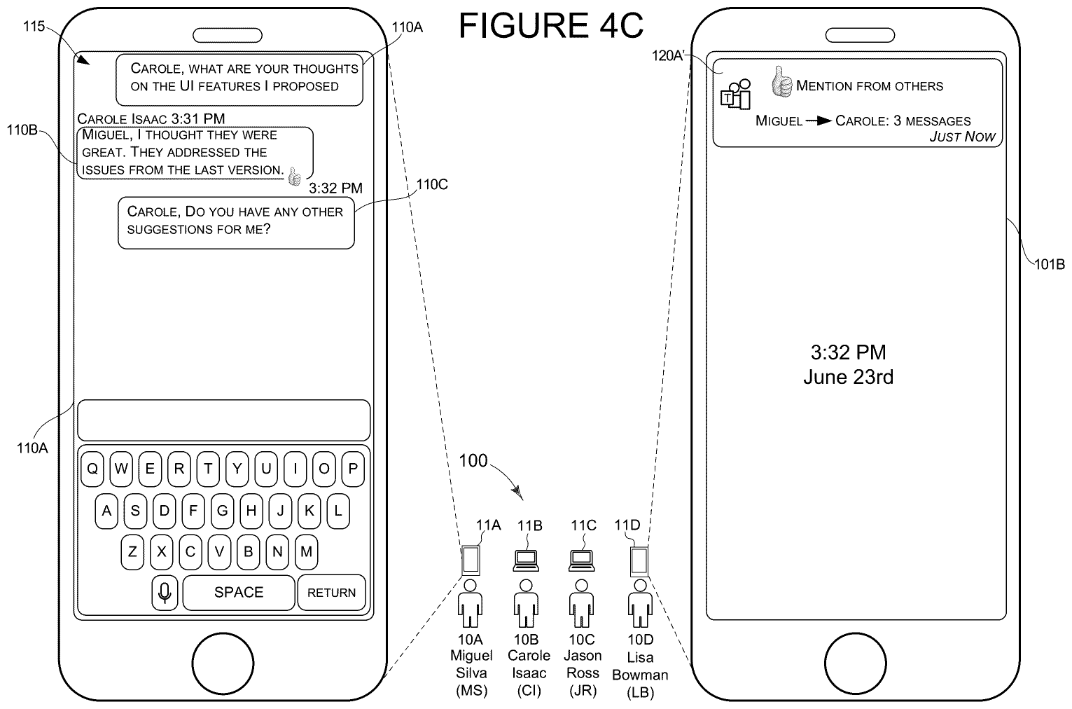

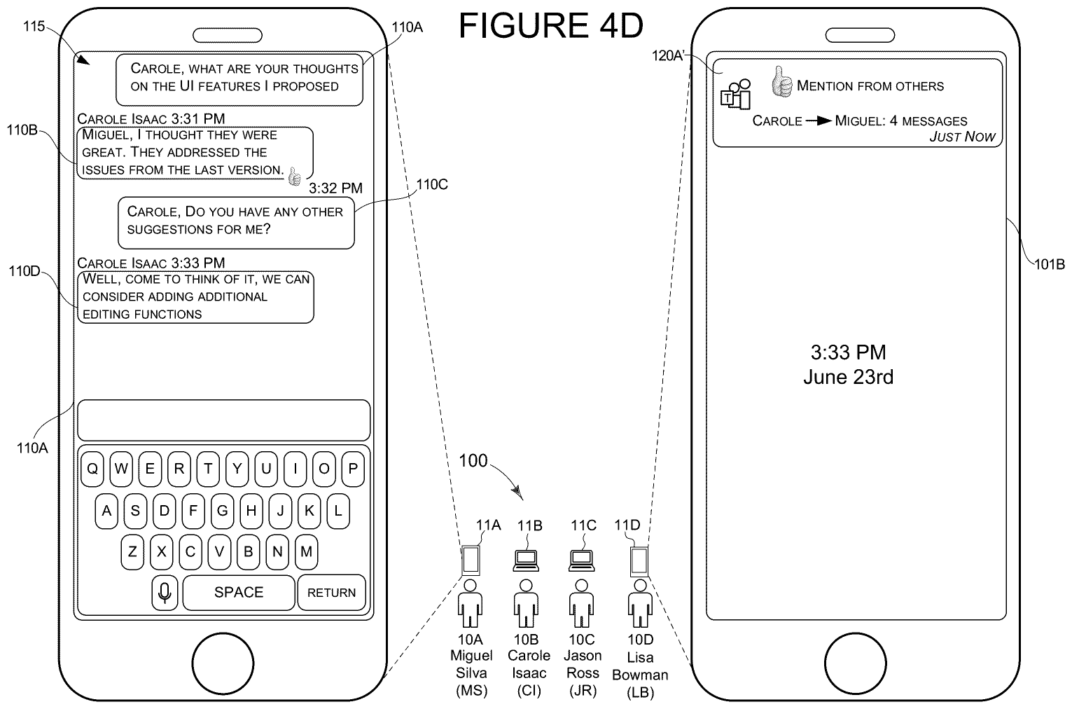

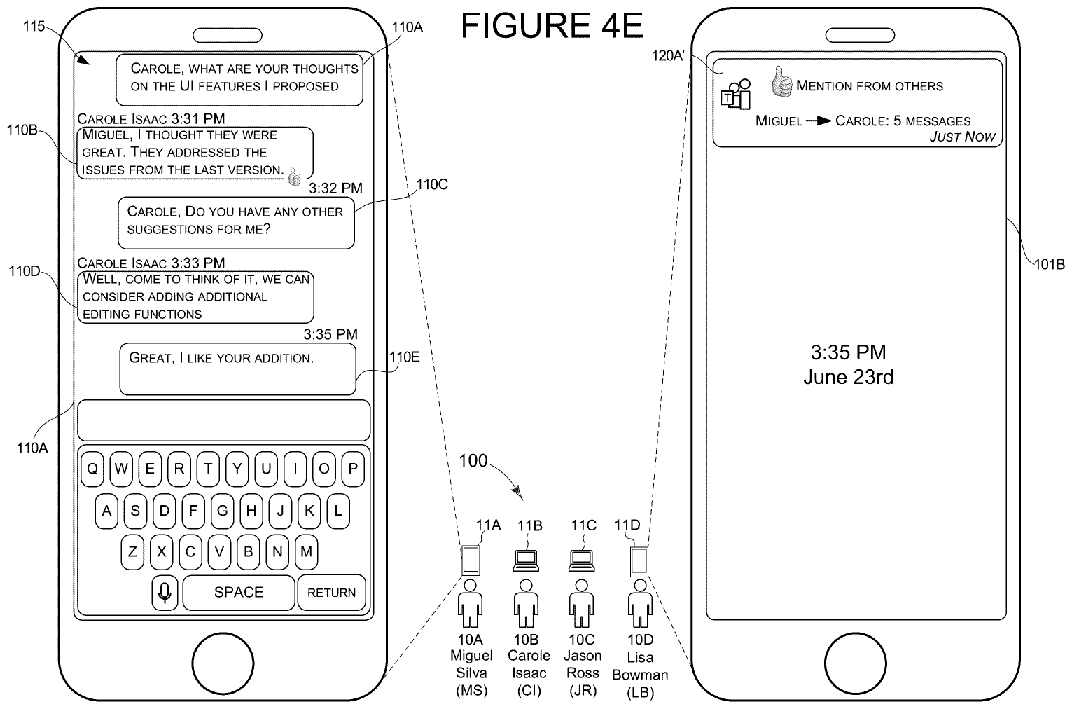

Turning now FIGS. 4A-4E, an example of customized notifications that convey specific types of activity pertaining to a thread are shown and described below. In such embodiments, the customized notifications can show that a subset of users of a meeting are engaged in a conversation. This may include a scenario where messages are directed toward the subset of users but other users in a meeting have permissions to view the messages. The system can analyze each received message of a thread and determine when a group of messages are directed to a specific group of people. In the example of FIGS. 4A-4E, the first message is directed to Carole, and the second message is directed to Miguel. When this type of activity is detected, the system can generate a customized notification that shows the identities of the subset of users and a number of interactions between those users. The customized notification can be displayed to users other than the subset of users (User C and User D), while the subset of users engaged in the directed conversation (User A and User B) receive more detailed notifications showing summaries of the exchanged messages.

In some embodiments, the system can start by displaying a first type of notification that shows more detailed summaries of received messages to all users. Then, in response to the detection of a subset of users sending directed messages to one another, the system can transition to a second type of notification, e.g., customized notifications that show the activity of a subset of users. The custom notifications can be directed to the users of a meeting other than the subset of users. As shown in FIG. 4A, in response to detecting receipt of the first message, the system can determine a category for the first message. The category of the first message can be determined using the above-described techniques of generating a query to an LLM. In this example, the first message is determined as being a question. In addition, the system determines that the first message is from the second user and directed to the second user. The system then displays text in the notification indicating the determined category, where the notification labels the first message as a question. As shown in FIG. 4B, in response to detecting receipt of the second message, the system can determine a category for the second message. The category of the second message can be determined using the using the above-described techniques of generating a query to an LLM. In this example, the second message is determined as being an answer to the question of the first message. In addition, the system determines that the second message is from the second user and directed to the first user. The system then displays text in a modified version of the notification 120A′ indicating the determined category, where the notification labels the second message as an answer to the question of the first message.

Then, as shown in FIGS. 4C through 4E, when additional messages are received relating to the determined category, and the additional messages are directed to the subset of users, those messages can cause the generation of the customized notifications showing messaging activity of the subset of users. These types of customized notifications can be limited to showing a representation of the message flow between the subset of users, and not necessarily display content. For example, as shown in FIG. 4C, the customized notifications 120A′ may display an arrow between usernames of the subset of users to show who sent, and who received, the last message.

In some embodiments, the customized notifications 120A′ showing messaging activity of the subset of users can be displayed in response to determining that messages directed to the subset of users have reached a predetermined threshold. In present example, the predetermined threshold is two, thus the third message that is determined to be directed to the subset of users, User A and User B, causes the generation of the customized notifications 120A′, as shown in FIG. 4C.

The customized notifications 120A′ are sent to the other users who are not included in the subset of users, such as the third user 10C and fourth user 10D. In addition, the subset of users may continue to receive the first type of notification, which includes a summary of the message content and a listing of the message categories. Alternatively, the subset of users may continue to receive the first type of notification, which includes a summary of the message content and a listing of the message categories.

The subset of users can be identified by the use of identifiers in each message. This can include an @ mention or a listing of a name of a user. In some cases, the subset of users can be identified by the use of an AI engine, such as a large language model. For example, the subset of users can be identified by sending a group of messages to a LLM with a prompt directing the LLM to determine if the three messages are related and if the three messages are directed to a specific set of people. Thus, even if first names or nicknames are used, the LLM can be used to determine if the messages are directed to the subset of users.

The subset of users can also be identified even when the messages do not identify a specific name. For example, as shown in FIG. 4D, when the fourth message is received, the system sends the fourth message with the previous messages to the LLM with a prompt that causes the LLM to determine if the four messages are related and if the four messages are directed to the same participants. An example prompt can include the text: is the fourth message directed to the same people listed in the first three messages,” or “is the fourth message from the same author of the second message.” When the LLM generates data indicating that the interactions are a direct conversation between a specific subset of users, e.g., such as User A and User B, the system can define the first user 10A and the second user 10B as members of the subset of users. The same can be done with the fifth message as shown in FIG. 4E. Each time the system determines a new message is directed to the subset of users, the system increments the counter in the activity-based notification 120A, as shown in FIG. 4C through FIG. 4E.

The activity-based notification can include the names of the subset of users and a direction in which the messages are being sent. As shown in FIG. 4C, since the fourth user 10D is not engaged in the conversation of a subset of users, the fourth device 11D may display in notification that shows that a message was sent from Miguel and that the message was directed to Carole. Then, as shown in FIG. 4D, since the fourth user 10D is not engaged in the conversation of a subset of users, the fourth device 11D may display in notification that shows that a message was sent from Carole and that the message was directed to Miguel. Then, as shown in FIG. 4D and FIG. 4E, additional notifications can show that the subset of users continued a conversation that is directed toward one another but yet the other individuals on the thread were still notified of this activity. This type of notification provides a contextually relevant notification that lets other people know about the activity but such notifications do not require computing resources to display content or additional details that may not be of interest to the users that are not engaged in the conversation. As also shown in the figures, the custom notification can also show reactions to the conversation. The custom notification can also identify who sent each reaction or if the reaction is from a member of the subset of users or other users.

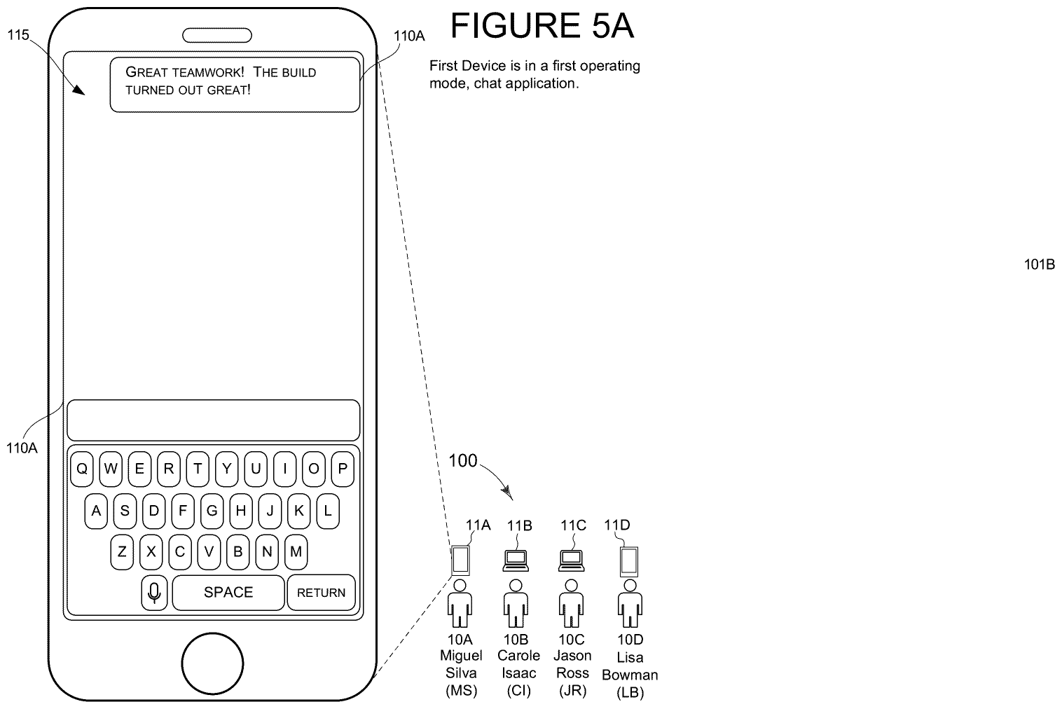

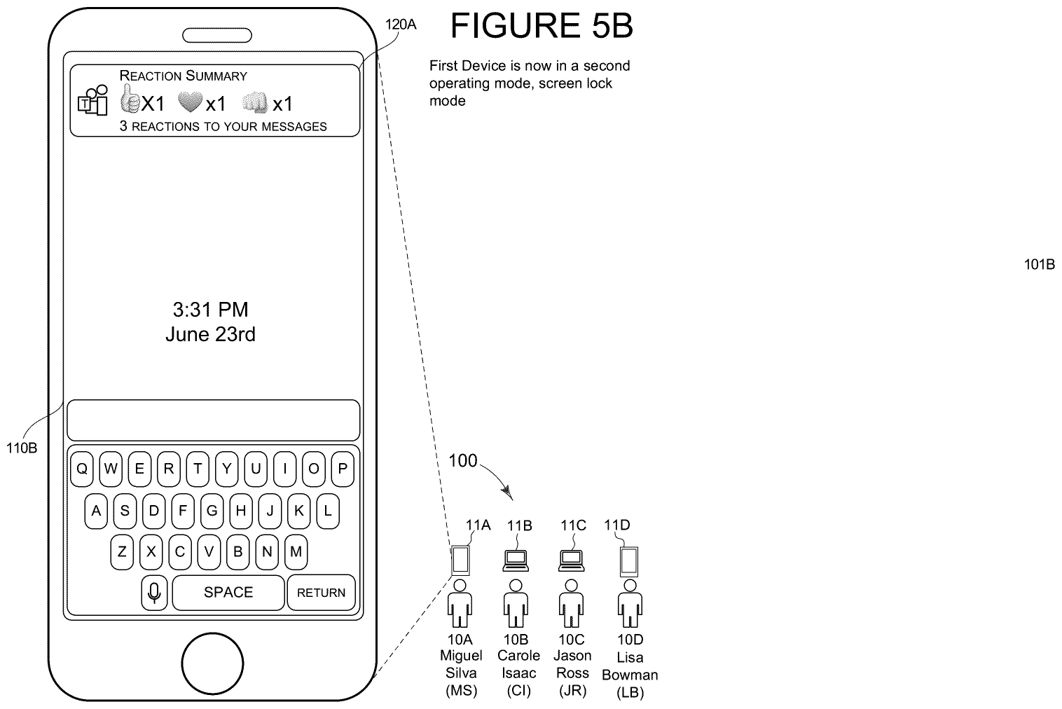

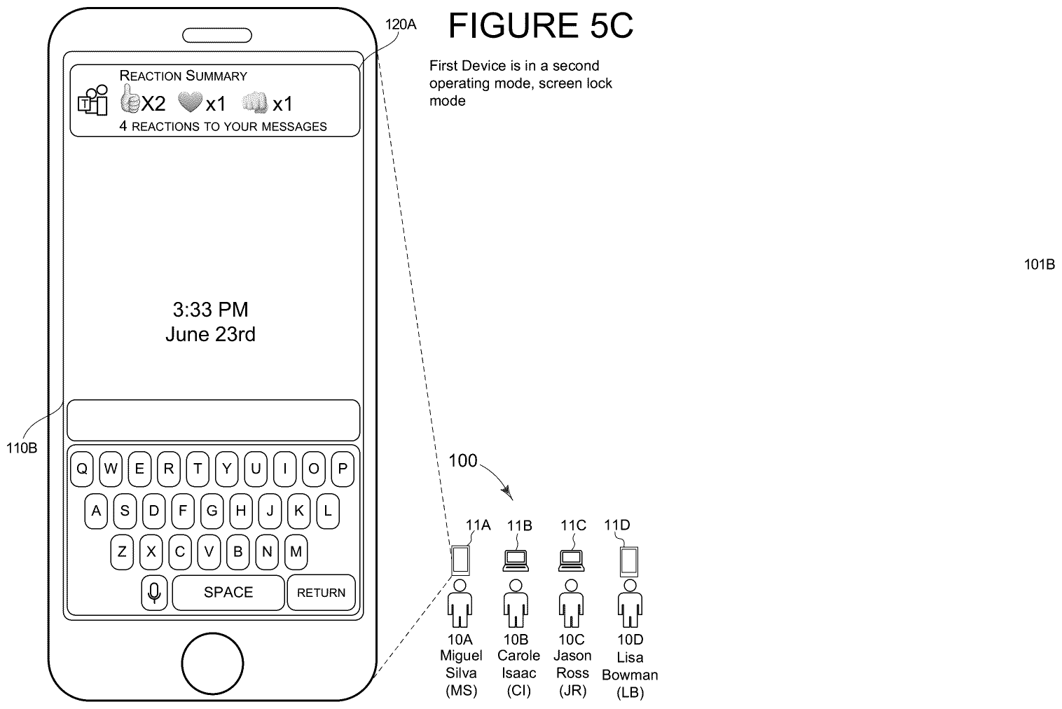

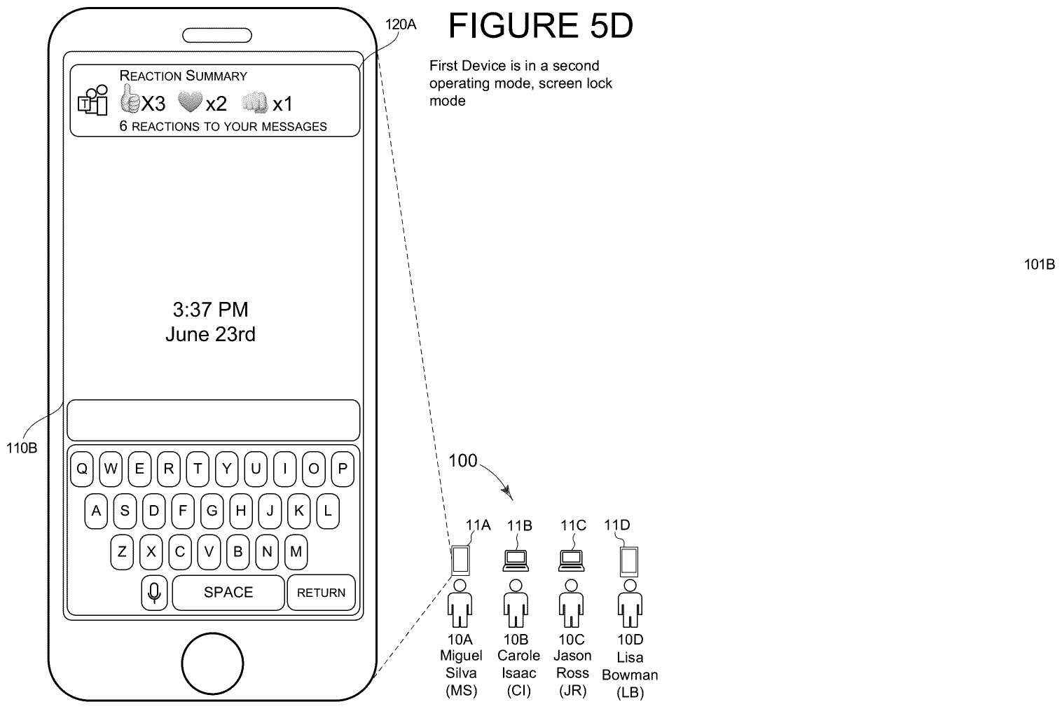

Turning now FIGS. 5A-5D, another example of a customized notification is shown and described below. In this example, a notification that tallies reactions is displayed on a device of the user that sent the original message. For example, FIG. 5A illustrates the first user interface arrangement showing a first message sent by a first device operating in a first mode. FIG. 5B illustrates the second user interface arrangement showing a notification displayed on the first device operating a second mode, such as a lock screen mode. The notification shows a number of reactions for the message sent by the first device. Then, as additional reactions are received the system increments the number of reactions for the message. As shown in FIG. 5C and FIG. 5D, the number of reactions can maintain a count for each type of reaction.

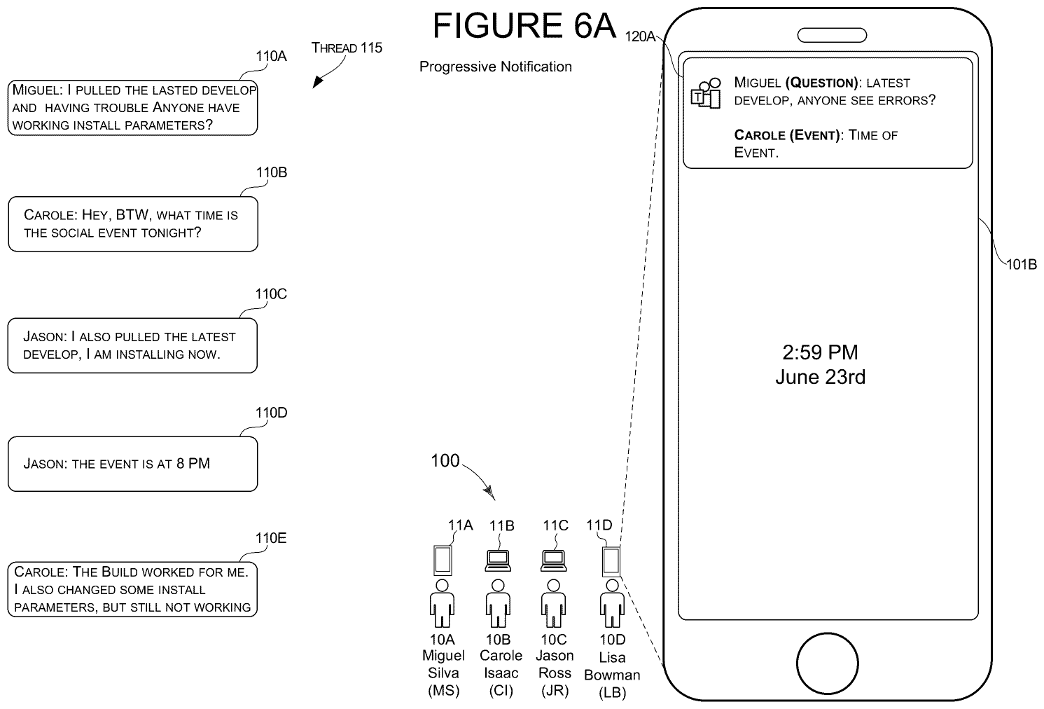

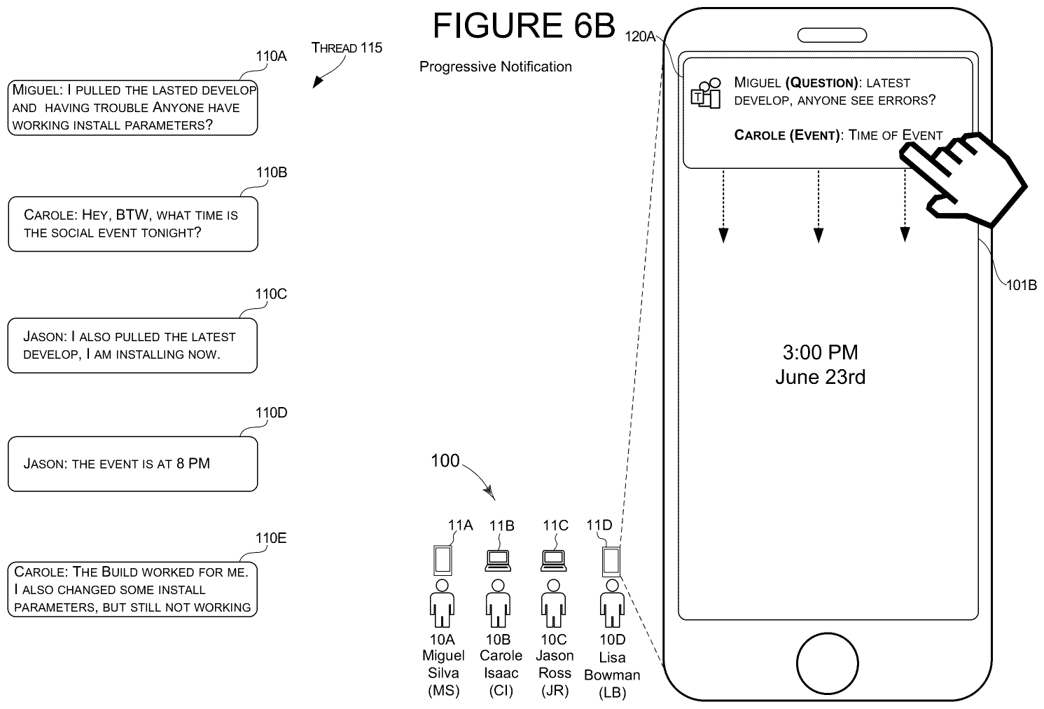

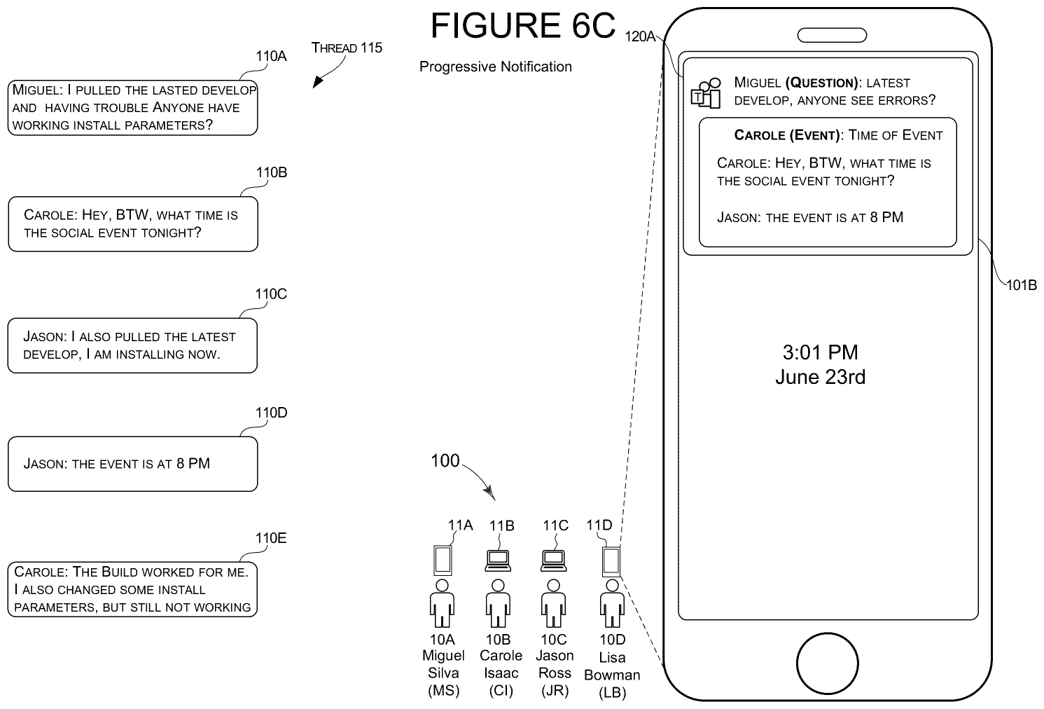

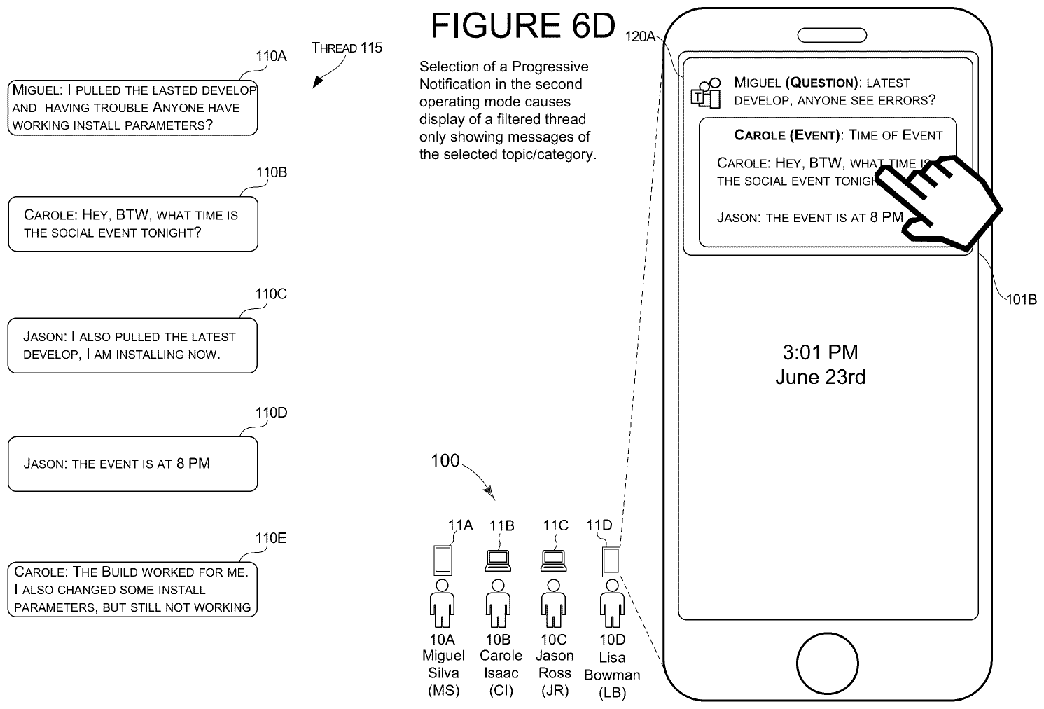

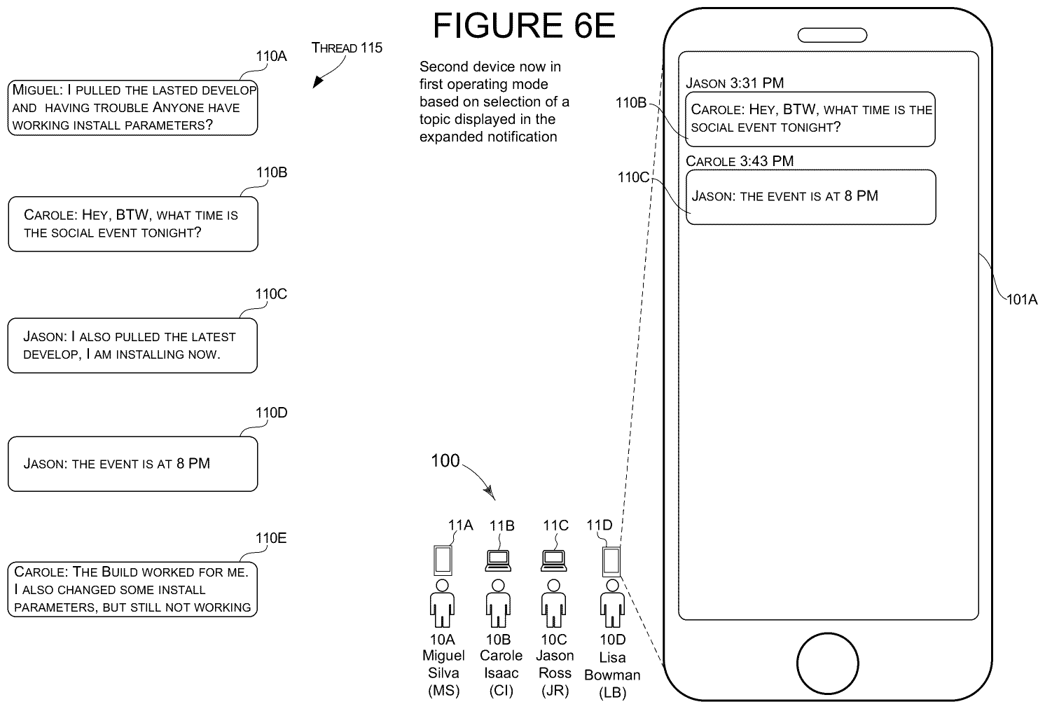

Turning now FIGS. 6A-6E, another example of a customized notification is shown and described below. In this example, a notification is configured to show multiple topics. When a user selects one of the topics, the notification can expand and show content from messages pertaining to the selected topic. In some embodiments, when a user selects one of the topics, the notification can expand and only display additional content from messages pertaining to the selected topic. This may include restricting the display of content from other messages that do not pertain to the selected topic. Such embodiments may include restricting the display of additional content from other messages that do not pertain to the selected topic. For example, the notification may already display a summary of the other messages or excerpts of the other messages, but the expansion of the notification does not include displaying additional content of the other messages than what is already displayed prior to the expansion. In some embodiments, when a user selects one of the topics, the notification can expand and display additional content from messages pertaining to the selected topic, while maintaining the display of an expert or a summary of the other messages that do not pertain to the selected topic.

FIG. 6A illustrates a first phase of a process where a computer displays a first user interface arrangement having an expandable notification that is displayed in a lock screen mode. In this example, a thread 115 has messages pertaining to a first topic (110A, 110C and 110E), and messages pertaining to a second topic (110B and 110D). FIG. 6B and FIG. 6C illustrates a process where a computer displays a first user interface arrangement having an expandable notification that is displayed in a lock screen mode, where a user input causes the expandable notification to increase in size and show additional content of received messages. As shown in FIG. 6C, while in the lock screen mode, a user selection of a topic can cause a display of messages or message summaries for the selected topic. The notification can increase in size to show additional content of received messages for the selected topic. Then, as shown in FIG. 6D, a user selection received at the expanded notification, causes the device to transition to another operating mode where the device is unlocked and displaying a message application. The device may prompt the user to provide credentials before transitioning to the unlocked mode. In addition, when in the unlocked mode, and in response to the input received at the expanded notification, the messaging application can be configured to only show messages related to the selected topic, as shown in FIG. 6E.

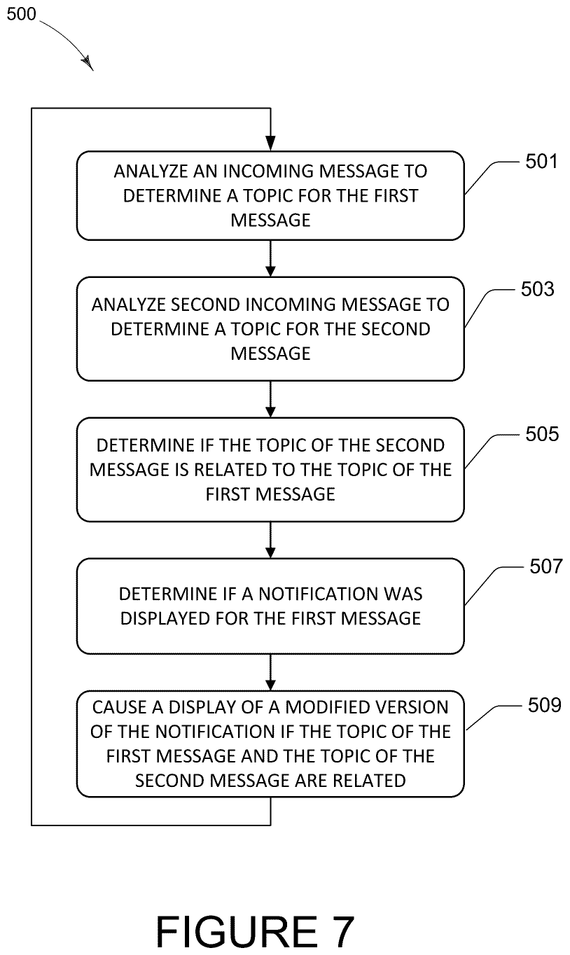

Turning now to FIG. 7, aspects of a routine 500 providing adaptable notifications are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an NLP algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the position or state of any device may be used in operations described herein.

The routine 500 includes an operation 501 where the system analyzes a first message to determine a topic for the first message. This can be accomplished by the use of one or more prompts that are sent to a LLM with the first message. Using any of the examples described above, the analysis of the first message can include the use a generated prompt that is communicated with the first message to a module executing one or more NLP algorithms. Similar to any of the operations described herein, the analysis of the first message can be performed by any device receiving or sending the message, and/or on a server managing the communication of the messages.

At operation 503, the system analyzes a second message to determine a topic for the second message. This can be accomplished by the use of one or more prompts that is send to the LLM with the second message.

At operation 505 the system generates a query for causing the LLM to determine if the first message is related to the second message. For example, a query can be sent with both messages with any metadata indicating a topic of each message, and query can cause the LLM to determine if the messages are related, and the LLM can be instructed to generate a confidence score for the response.

At operation 507, the system can determine if a notification was delivered for the first message. This can include a verification that the first notification was actually displayed on a device.

Then, at operation 509, if the system determines that the messages are related, and determines that this determination has a threshold confidence score, the system can cause a generation of a customized notification, e.g., modified notification, or suppress a notification for the second message. In some embodiments, the customized notification or the suppression of a notification for the second message can be in response to also determining that the first notification was actually displayed on a device.

The following clauses are to further the above-described routine. Clause A: The routine can cause one or more computing devices to manage notifications for messages for a thread, the method comprising: receiving a first message (110A) pertaining to a first topic; in response to receiving the first message (110A), causing a display of a first notification (120A) comprising at least a portion of the first message (110A); receiving a second message (110B) pertaining to a second topic; in response to receiving the second message (110B), causing a display of a second notification (120B) comprising at least a portion of the second message (110B); receiving a third message (110C); analyzing the third message (110C) to determine that a topic of the third message (110C) has a threshold level of relevancy to the first topic of the first message (110A); and in response to determining that the topic of the third message (110C) has a threshold level of relevancy to the first topic of the first message (110A) and determining that the first notification (120A) for the first message (110A) has been displayed, suppressing the display of a new notification for the third message (110C) or causing a display of a modified version of the notification (120A′) for the first message (110A), wherein the modified version of the notification (120A′) includes at least a portion of the third message (110C) and at least a portion of the first message (110A), wherein the modified version of the notification (120A′) does not include the entire message of the first message or the third message, and wherein the modified version of the notification (120A′) excludes content from the second message (110B).

Clause B: The routine of clause A, wherein the first topic pertains to a question, and wherein the topic of the third message pertains to an answer to the question, wherein the first notification displays a graphical element indicating that the first message is a question, wherein the modified version of the notification displays a graphical element indicating that the third message is the answer to the question.

Clause C: The routine of clauses A-B, further comprising: generating a new notification in response to receiving a new message pertaining to the second topic, wherein the new notification displays the first topic, the second topic, at least a portion of the first message, and at least a portion of the new message.

Clause D: The routine of clauses A-C, further comprising: generating a first query in response to receiving the first message, wherein the first query causes a language model to determine a topic for the first message; communicating the first query and the first message to an interface of the language model, causing the language model to determine the first topic; generating a second query in response to receiving the second message, wherein the second query causes the language model to determine a topic for the second message; communicating the second query and the second message to the interface of the language model, causing the language model to determine the topic for the second message; communicating instructions to the language model to cause the language model to determine if the topic of the first message has the threshold level of relevancy with the topic of the second message; and causing the display of the second notification comprising at least the portion of the second message in response to determining that the topic of the first message does not have the threshold level of relevancy with the topic of the second message.

Clause E: The routine of clauses A-D, further comprising: communicating instructions to the language model to cause the language model to determine a confidence score with respect to a relevancy level between the topic of the first message and the topic of the second message, where the relevancy level is compared to the threshold level of relevancy to control the display of the second notification; and causing the display of the second notification comprising at least the portion of the second message in response to determining that the confidence score with respect to a relevancy level is below a threshold.

Clause F: The routine of clauses A-E, wherein the system provides access to a set of participants having to messages of the thread, wherein the routine further comprises: determining that messages exchanged on the thread are directed to a subset of participants of the set of participants; and in response to determining that messages exchanged on the thread are directed to the subset of participants for a predetermined number of messages, updating the modified notification to display graphical representations indicating at least one sender and at least one recipient of the messages exchanged on the thread are directed to the subset of participants.

Clause G: The routine of clauses A-F, wherein a second notification includes a description of the first topic and a description of the second topic, wherein the description of the first topic is selectable for causing the second notification to expand in size to show content of the first message, wherein the description of the second topic is selectable for causing the second notification to expand in size to show content of the second message, wherein a selection of the content of the first message that is displayed within an expanded version of the second notification causes a device displaying the second notification to transition from a first operating state that does not display the thread to a second operating state that displays messages pertaining to the first topic, wherein a selection of the content of the second message that is displayed within the expanded version of the second notification causes the device displaying the second notification to transition from the first operating state that does not display the thread to the second operating state that displays messages pertaining to the second topic.

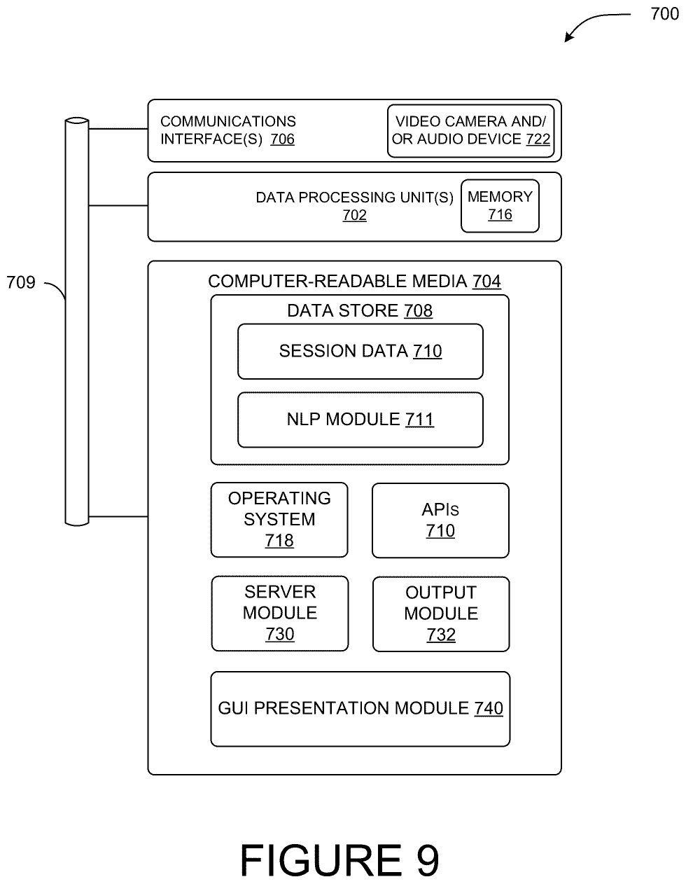

FIG. 9 is a diagram illustrating an example environment 600 in which a system 602 can implement the techniques disclosed herein. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 604. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 602 of FIG. 9 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses. Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 9 illustrates that client computing device 606(1) is in some way connected to a display device (e.g., a display screen 629(N)), which can display a UI according to the techniques described herein.

In the example environment 600 of FIG. 9, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 9) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 9, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a direction and location of a representation. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

FIG. 10 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store session data 710 (e.g., session data 636 as shown in FIG. 9), profile data 712 (e.g., associated with a participant profile), and/or other data. The session data 710 can include a total number of participants (e.g., users and/or client computing devices) in a communication session, activity that occurs in the communication session, a list of invitees to the communication session, and/or other data related to when and how the communication session is conducted or hosted. The data store 708 may also include session data 710, such as the content that includes video, audio, or other content that can be shared in a chat thread. The data store 708 may also include an NLP module 771, which can include a large language model. The NLP module can also be part of a remote system. In such embodiments, the queries and the messages can be sent to the remote system for processing, and any device of the system 700 can receive the results generated by the NLP module on the remote system.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

I/We claim:

1. A method for managing notifications for messages for a thread, the method comprising:
receiving a first message pertaining to a first topic;
in response to receiving the first message, causing a display of a first notification comprising at least a portion of the first message;
receiving a second message pertaining to a second topic;
in response to receiving the second message, causing a display of a second notification comprising at least a portion of the second message;
receiving a third message;
analyzing the third message to determine that a topic of the third message has a threshold level of relevancy to the first topic of the first message; and
in response to determining that the topic of the third message has a threshold level of relevancy to the first topic of the first message and determining that the first notification for the first message has been displayed, suppressing the display of a new notification for the third message or causing a display of a modified version of the notification for the first message, wherein the modified version of the notification includes at least a portion of the third message and at least a portion of the first message, wherein the modified version of the notification does not include the entire message of the first message or the third message, and wherein the modified version of the notification excludes content from the second message.

2. The method of claim 1, wherein the first topic pertains to a question, and wherein the topic of the third message pertains to an answer to the question, wherein the first notification displays a graphical element indicating that the first message is a question, wherein the modified version of the notification displays a graphical element indicating that the third message is the answer to the question.

3. The method of claim 1, further comprising: generating a new notification in response to receiving a new message pertaining to the second topic, wherein the new notification displays the first topic, the second topic, at least a portion of the first message, and at least a portion of the new message.

4. The method of claim 1, further comprising:
generating a first query in response to receiving the first message, wherein the first query causes a language model to determine a topic for the first message;
communicating the first query and the first message to an interface of the language model, causing the language model to determine the first topic;
generating a second query in response to receiving the second message, wherein the second query causes the language model to determine a topic for the second message;
communicating the second query and the second message to the interface of the language model, causing the language model to determine the topic for the second message;
communicating instructions to the language model to cause the language model to determine if the topic of the first message has the threshold level of relevancy with the topic of the second message; and
causing the display of the second notification comprising at least the portion of the second message in response to determining that the topic of the first message does not have the threshold level of relevancy with the topic of the second message.

5. The method of claim 4, further comprising:
communicating instructions to the language model to cause the language model to determine a confidence score with respect to a relevancy level between the topic of the first message and the topic of the second message, where the relevancy level is compared to the threshold level of relevancy to control the display of the second notification; and
causing the display of the second notification comprising at least the portion of the second message in response to determining that the confidence score with respect to a relevancy level is below a threshold.

6. The method of claim 1, wherein the system provides access to a set of participants having to messages of the thread, wherein the method further comprises:
determining that messages exchanged on the thread are directed to a subset of participants of the set of participants; and
in response to determining that messages exchanged on the thread are directed to the subset of participants for a predetermined number of messages, updating the modified notification to display graphical representations indicating at least one sender and at least one recipient of the messages exchanged on the thread are directed to the subset of participants.

7. The method of claim 1, wherein a second notification includes a description of the first topic and a description of the second topic, wherein the description of the first topic is selectable for causing the second notification to expand in size to show content of the first message, wherein the description of the second topic is selectable for causing the second notification to expand in size to show content of the second message, wherein a selection of the content of the first message that is displayed within an expanded version of the second notification causes a device displaying the second notification to transition from a first operating state that does not display the thread to a second operating state that displays messages pertaining to the first topic, wherein a selection of the content of the second message that is displayed within the expanded version of the second notification causes the device displaying the second notification to transition from the first operating state that does not display the thread to the second operating state that displays messages pertaining to the second topic.

8. A system for managing notifications for messages of a thread, the system comprising:
one or more processing units; and
a computer-readable storage medium having encoded thereon computer-executable instructions to cause the one or more processing units to:
receive a first message pertaining to a first topic;
in response to receiving the first message, cause a display of a first notification comprising at least a portion of the first message;
receive a second message pertaining to a second topic;
in response to receiving the second message, cause a display of a second notification comprising at least a portion of the second message;
receive a third message;
analyze the third message to determine that a topic of the third message has a threshold level of relevancy to the first topic of the first message; and
in response to determining that the topic of the third message has a threshold level of relevancy to the first topic of the first message and determining that the first notification for the first message has been displayed, suppress the display of a new notification for the third message or cause a display of a modified version of the notification for the first message, wherein the modified version of the notification includes at least a portion of the third message and at least a portion of the first message, wherein the modified version of the notification does not include the entire message of the first message or the third message, and wherein the modified version of the notification excludes content from the second message.

9. The system of claim 8, wherein the first topic pertains to a question, and wherein the topic of the third message pertains to an answer to the question, wherein the first notification displays a graphical element indicating that the first message is a question, wherein the modified version of the notification displays a graphical element indicating that the third message is the answer to the question.

10. The system of claim 8, the instructions further cause the one or more processing units to: generate a new notification in response to receiving a new message pertaining to the second topic, wherein the new notification displays the first topic, the second topic, at least a portion of the first message, and at least a portion of the new message.

11. The system of claim 8, wherein the instructions further cause the one or more processing units to:
generate a first query in response to receiving the first message, wherein the first query causes a language model to determine a topic for the first message;
communicate the first query and the first message to an interface of the language model, causing the language model to determine the first topic;
generate a second query in response to receiving the second message, wherein the second query causes the language model to determine a topic for the second message;
communicate the second query and the second message to the interface of the language model, causing the language model to determine the topic for the second message;
communicate instructions to the language model to cause the language model to determine if the topic of the first message has the threshold level of relevancy with the topic of the second message; and
cause the display of the second notification comprising at least the portion of the second message in response to determining that the topic of the first message does not have the threshold level of relevancy with the topic of the second message.

12. The system of claim 11, wherein the instructions further cause the one or more processing units to:
communicate instructions to the language model to cause the language model to determine a confidence score with respect to a relevancy level between the topic of the first message and the topic of the second message, where the relevancy level is compared to the threshold level of relevancy to control the display of the second notification; and
cause the display of the second notification comprising at least the portion of the second message in response to determining that the confidence score with respect to a relevancy level is below a threshold.

13. The system of claim 8, wherein the system provides access to a set of participants having to messages of the thread, wherein the instructions further cause the one or more processing units to:
determine that messages exchanged on the thread are directed to a subset of participants of the set of participants; and
in response to determining that messages exchanged on the thread are directed to the subset of participants for a predetermined number of messages, update the modified notification to display graphical representations indicating at least one sender and at least one recipient of the messages exchanged on the thread are directed to the subset of participants.

14. The system of claim 8, wherein a second notification includes a description of the first topic and a description of the second topic, wherein the description of the first topic is selectable for causing the second notification to expand in size to show content of the first message, wherein the description of the second topic is selectable for causing the second notification to expand in size to show content of the second message, wherein a selection of the content of the first message that is displayed within an expanded version of the second notification causes a device displaying the second notification to transition from a first operating state that does not display the thread to a second operating state that displays messages pertaining to the first topic, wherein a selection of the content of the second message that is displayed within the expanded version of the second notification causes the device displaying the second notification to transition from the first operating state that does not display the thread to the second operating state that displays messages pertaining to the second topic.

15. A computer-readable storage medium for a system that manages notifications for messages of a thread, the computer-readable storage medium having encoded thereon computer-executable instructions to cause one or more processing units of a system to:
receive a first message pertaining to a first topic;
in response to receiving the first message, cause a display of a first notification comprising at least a portion of the first message;
receive a second message pertaining to a second topic;
in response to receiving the second message, cause a display of a second notification comprising at least a portion of the second message;
receive a third message;
analyze the third message to determine that a topic of the third message has a threshold level of relevancy to the first topic of the first message; and
in response to determining that the topic of the third message has a threshold level of relevancy to the first topic of the first message and determining that the first notification for the first message has been displayed, suppress the display of a new notification for the third message or cause a display of a modified version of the notification for the first message, wherein the modified version of the notification includes at least a portion of the third message and at least a portion of the first message, wherein the modified version of the notification does not include the entire message of the first message or the third message, and wherein the modified version of the notification excludes content from the second message.

16. The computer-readable storage medium of claim 15, wherein the first topic pertains to a question, and wherein the topic of the third message pertains to an answer to the question, wherein the first notification displays a graphical element indicating that the first message is a question, wherein the modified version of the notification displays a graphical element indicating that the third message is the answer to the question.

17. The computer-readable storage medium of claim 15, the instructions further cause the one or more processing units to: generate a new notification in response to receiving a new message pertaining to the second topic, wherein the new notification displays the first topic, the second topic, at least a portion of the first message, and at least a portion of the new message.

18. The computer-readable storage medium of claim 15, wherein the instructions further cause the one or more processing units to:
generate a first query in response to receiving the first message, wherein the first query causes a language model to determine a topic for the first message;
communicate the first query and the first message to an interface of the language model, causing the language model to determine the first topic;
generate a second query in response to receiving the second message, wherein the second query causes the language model to determine a topic for the second message;
communicate the second query and the second message to the interface of the language model, causing the language model to determine the topic for the second message;
communicate instructions to the language model to cause the language model to determine if the topic of the first message has the threshold level of relevancy with the topic of the second message; and
cause the display of the second notification comprising at least the portion of the second message in response to determining that the topic of the first message does not have the threshold level of relevancy with the topic of the second message.

19. The computer-readable storage medium of claim 18, wherein the instructions further cause the one or more processing units to:
communicate instructions to the language model to cause the language model to determine a confidence score with respect to a relevancy level between the topic of the first message and the topic of the second message, where the relevancy level is compared to the threshold level of relevancy to control the display of the second notification; and
cause the display of the second notification comprising at least the portion of the second message in response to determining that the confidence score with respect to a relevancy level is below a threshold.

20. The computer-readable storage medium of claim 15, wherein the system provides access to a set of participants having to messages of the thread, wherein the instructions further cause the one or more processing units to:
determine that messages exchanged on the thread are directed to a subset of participants of the set of participants; and
in response to determining that messages exchanged on the thread are directed to the subset of participants for a predetermined number of messages, update the modified notification to display graphical representations indicating at least one sender and at least one recipient of the messages exchanged on the thread are directed to the subset of participants.
